(19) United States
(12) Patent Application Publication
(10) Pub. No.: US 2022/0019822 A1
(43) Pub. Date: Jan. 20, 2022

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Tomonori Tanaka, Saitama (JP)

(21) Appl. No.: 17/376,792

(22) Filed: Jul. 15, 2021

(30) Foreign Application Priority Data
Jul. 20, 2020 (JP) 2020-123601

(51) Int. Cl. G06K 9/00; G06T 7/70; B60R 1/00

(52) U.S. Cl. CPC G06K 9/00832; G06K 9/00771; G06T 7/70; G06T 2207/30268; G06T 2207/30242; G06T 2207/30196; B60R 2300/8006; B60R 1/00

(57) ABSTRACT

An information processing apparatus includes a detection unit configured to detect a counting target object from an input image, a storage unit configured to store a behavior of the object detected by the detection unit, a determination unit configured to determine whether the object having become undetected has moved into a specific area based on the behavior of the object stored by the storage unit in a case where the object detected by the detection unit has become undetected, and a counting unit configured to count a number of objects in a counting target area in the input image based on a detection result of the object by the detection unit and a determination result by the determination unit.

### BACKGROUND

### Field of the Disclosure

The present disclosure relates to an information processing apparatus, an information processing method, and a storage medium.

### Description of the Related Art

Conventionally, there has been known a technique for counting the number of people based on an image captured by a surveillance camera installed on a ceiling portion.

Japanese Patent Application Laid-Open No. 2016-166066 discusses an elevator system that detects the number of passengers in an elevator hall and estimates the number of passengers in a blind spot area of a surveillance camera based on elevator control information.

However, the technique discussed in Japanese Patent Application Laid-Open No. 2016-166066 undesirably may lead to a reduction in the accuracy of estimating the number of passengers in the blind spot area as time passes.

### SUMMARY OF THE DISCLOSURE

The present disclosure is directed to a technique capable of appropriately estimating the number of counting target objects even when a blind spot area exists in a counting target area.

According to an aspect of the present disclosure, an information processing apparatus includes a detection unit configured to detect a counting target object from an input image, a storage unit configured to store a behavior of the object detected by the detection unit, a determination unit configured to determine whether the object having become undetected has moved into a specific area based on the behavior of the object stored by the storage unit in a case where the object detected by the detection unit has become undetected, and a counting unit configured to count a number of objects in a counting target area in the input image based on a detection result of the object by the detection unit and a determination result by the determination unit.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an imaging apparatus according to a first exemplary embodiment of the present disclosure.

FIG. 2 illustrates an installation example of the imaging apparatus.

FIG. 3 illustrates a blind spot area.

FIG. 4 is a flowchart illustrating processing performed by the imaging apparatus according to the first exemplary embodiment.

FIG. 5 is a table illustrating an example of human body detection information.

FIG. 6 is diagram illustrating a coordinate system for a captured image.

FIG. 7 is a table illustrating an example of human body behavior information.

FIG. 8 is a table illustrating an example of the human body detection information.

FIG. 9 is a table illustrating an example of the human body detection information.

FIG. 10 is a flowchart illustrating processing performed in step S4 in FIG. 4.

FIG. 11 is a diagram illustrating a movement of a human body from a non-blind spot area into a blind spot area.

FIG. 12 is a flowchart illustrating processing performed by an imaging apparatus according to a second exemplary embodiment.

### DESCRIPTION OF THE EMBODIMENTS

In the following description, exemplary embodiments for implementing the present disclosure will be described in detail with reference to the attached drawings.

The exemplary embodiments that will be described below are merely an example of how the present disclosure can be embodied, and shall be appropriately modified or changed depending on the configuration of an apparatus to which the present disclosure is applied and various kinds of conditions. Thus, the present disclosure is in no way limited to the following exemplary embodiments.

A first exemplary embodiments of the present disclosure will be described regarding a camera system that counts the number of counting target objects existing in a counting target area in an input image while handling a captured image (video image) captured by an imaging apparatus as the input image. The camera system according to the present exemplary embodiment includes an information processing apparatus that counts the number of passengers in a seat area while setting a human body as the above-described counting target object and setting the seat area in a vehicle such as a railroad vehicle as the above-described counting target area.

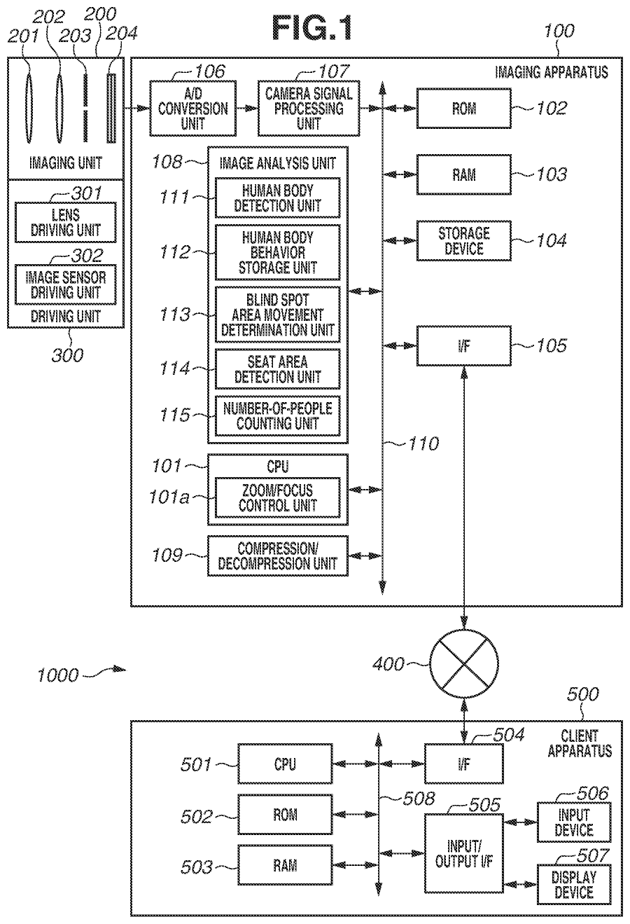

FIG. 1 is a block diagram illustrating an example of a configuration of a camera system 1000 according to the present exemplary embodiment.

The camera system 1000 includes an imaging apparatus 100. The imaging apparatus 100 can be a network camera that captures image data or moving image data via a lens. Further, the imaging apparatus 100 can be an interchangeable-lens imaging apparatus which an imaging unit 200 having an imaging optical system and a driving unit 300 can be attachable to and detachable from. Alternatively, the imaging apparatus 100 may be a lens-integrated imaging apparatus integrally including the imaging unit 200 and the driving unit 300.

The imaging apparatus 100 can transmit the captured image data or the like to a client apparatus 500 via a network 400 in response to a request from the client. Further, the imaging apparatus 100 may actively transmit the image data or the like to the client apparatus 500 connected in advance.

The network 400 includes pluralities of routers, switches, cables, and the like in compliance with a communication standard such as Ethernet®. The network 400 may support any communication standard, scale, and configuration as long as it is configured to be able to establish communication between the imaging apparatus 100 and the above-described client apparatus 500. The network 400 may be embodied by the Internet, a wired local area network (LAN), a wireless LAN, a wide area network (WAN), or a combination thereof.

The client apparatus 500 can be embodied by a commonly-used terminal apparatus, such as a personal computer (PC), a smart-phone, and a tablet-type PC. Further, the client apparatus 500 may be a server apparatus, or may be, for example, a dedicated controller apparatus for operating a remote camera.

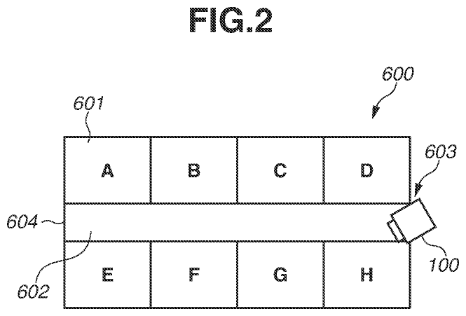

FIG. 2 is a diagram illustrating an installation example of the imaging apparatus 100.

The imaging apparatus 100 is installed on a ceiling portion of a vehicle 600, and, for example, counts the number of passengers present in a seat area 601 to recognize how much seats A to H are crowded. The seat area 601 and a non-seat area 602 are provided in the vehicle 600. In this case, the non-seat area 602 can be an aisle prepared between the seats A to D and the seats E to H. The passengers can enter and exit the vehicle 600 via an entrance/exit 603 or an entrance/exit 604, and move through the non-seat area 602 and sit down onto and leave the seats A to H provided in the seat area 601. Assume that the imaging apparatus 100 is installed at the end in the vehicle 600, more specifically, on the ceiling portion near the entrance/exit 603.

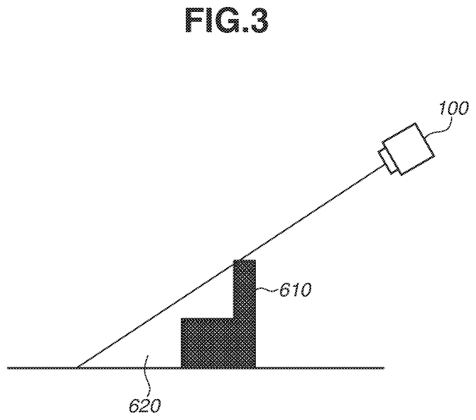

A backrest 610 is provided to each of the seats A to H as illustrated in FIG. 3. Thus, when the imaging apparatus 100 is installed at the end of the ceiling of the vehicle 600, a blind spot area 620, from which the imaging apparatus 100 cannot capture an image, is generated in the seat area 601 depending on the positional relationship between the imaging apparatus 100 and the backrest 610. If a passenger is seated and enters the blind spot area 620, this passenger cannot be imaged by the imaging apparatus 100, thereby making it impossible to detect this passenger from the captured image. For this reason, if the number of human bodies detected in the area corresponding to the seat area 601 in the captured image is counted as the number of passengers seated on the seats, some seat may be erroneously determined to be an empty seat despite the fact that a passenger is seated thereon and the number of people may be unable to be correctly counted.

In the present exemplary embodiment, the imaging apparatus 100 stores the behavior of the human body detected from the captured image. Then, when the human body detected in a non-blind spot area, from which the imaging apparatus 100 can capture an image, has becomes undetected, the imaging apparatus 100 determines whether the human body that has become undetected has moved into the blind spot area based on the behavior of the human body before the human body has become undetected. Then, the imaging apparatus 100 counts the number of people in the counting target area in consideration of the result of this determination. In this manner, the imaging apparatus 100 can count the number of people correctly even when there is a movement of a human body into the blind spot area.

In the following description, the configuration of each of units illustrated in FIG. 1 will be described. First, the imaging unit 200 and the driving unit 300 will be described.

The imaging unit 200 includes a zoom lens 201, a focus lens 202, a diaphragm 203, and an image sensor 204, which form the imaging optical system.

The driving unit 300 includes a lens driving unit 301 and an image sensor driving unit 302. The lens driving unit 301 moves the positions of the zoom lens 201 and the focus lens 202 along the optical axis based on focus/zoom setting positions instructed by a zoom/focus control unit 101a, which will be described below. Further, the lens driving unit 301 drives the diaphragm 203.

The image sensor driving unit 302 tilts the image sensor 204 based on the setting position of a tilt-shift angle instructed by the zoom/focus control unit 101a, which will be described below. More specifically, the rotational axis for tilting the image sensor 204 is located at the center of the imaging screen, and the image sensor 204 is tilted about this rotational axis. The image sensor 204 photoelectrically converts light passing through the zoom lens 201, the focus lens 202, and the diaphragm 203, thereby forming an analog image signal. The generated analog image signal is output to an analog-to-digital (A/D) conversion unit 106, which will be described below, after being subjected to amplification processing using sampling processing such as correlated double sampling.

The imaging apparatus 100 includes a central processing unit (CPU) 101, a read only memory (ROM) 102, a random access memory (RAM) 103, a storage device 104, an interface (I/F) 105, the A/D conversion unit 106, a camera signal processing unit 107, an image analysis unit 108, and a compression/decompression unit 109. The CPU 101 includes the zoom/focus control unit 101a. Further, the image analysis unit 108 includes a human body detection unit 111, a human body behavior storage unit 112, a blind spot area movement determination unit 113, a seat area detection unit 114, and a number-of-people count unit 115.

The CPU 101 comprehensively controls the operation of the imaging apparatus 100. The zoom/focus control unit 101a performs focus control using automatic focus (AF) or manual focus (MF).

The ROM 102 is a nonvolatile memory, such as an electrically erasable programmable ROM (EEPROM) and a flash memory. The ROM 102 stores a program and data required for the CPU 101 to perform processing. This program may be stored in the storage device 104 or a not-illustrated attachable/detachable storage medium. The RAM 103 is a volatile memory, such as a static RAM (SRAM) and a dynamic RAM (DRAM), and functions as, for example, a main memory or a work area of the CPU 101. The CPU 101 archives various kinds of functions and operations by loading a required program or the like from the ROM 102 into the RAM 103 via an internal bus 110 and executing this program or the like, when performing the processing.

The storage device 104 is a storage device such as a hard disk drive (HDD), a solid-state drive (SSD), and an embedded MultiMediaCard (eMMC).

The I/F 105 is a network interface for connecting to the network 400.

The A/D conversion unit 106 converts the analog image signal output from the imaging unit 200 into a digital image signal and outputs it to the camera signal processing unit 107.

The camera signal processing unit 107 generates a captured image (video image) by performing various kinds of image processing on the digital image signal. The various kinds of image processing include offset processing, gamma correction processing, gain processing, Red Green Blue (RGB) interpolation processing, noise reduction processing, contour correction processing, color tone correction processing, and light source-type determination processing.

The image analysis unit 108 carries out an image analysis, such as human body detection and moving object detection, using the captured image generated by the camera signal processing unit 107 as an input image.

The human body detection unit 111 detects a specific human body from the captured image based on image analysis processing following an existing algorithm. One example of the method for detecting the human body is a method that extracts at least outer shape information of an object as a feature amount and performs pattern matching processing. The outer shape information is a track information indicating the outer shape of the object, and can be Ω-shaped track information from a head portion to a shoulder portion. Alternatively, the human body detection may be carried out using image analysis processing such as face recognition.

Further, the human body detection unit 111 also identifies the human body at the same time as detecting the human body, and assigns an identification (ID) to each detected human body. One example of the method for identifying the human body is a method that extracts a color histogram of the detected human body and identifies the human body based on the color histogram. The method for detecting the human body and the method for identifying the human body are not limited to the above-described examples, and known methods can be employed as appropriate.

The human body behavior storage unit 112 stores the behavior of the human body detected by the human body detection unit 111. More specifically, the human body behavior storage unit 112 stores the history of the position of the human body detected by the human body detection unit 111 in the captured image, such as the history of the central coordinates of the outer shape of the human body, into the RAM 103 for each frame.

When the human body detected by the human body detection unit 111 becomes undetected, the blind spot area movement determination unit 113 determines whether the human body having become undetected has moved from the non-blind spot area into the blind spot area. More specifically, the blind spot area movement determination unit 113 estimates the position to which the human body has moved after the human body has become undetected based on the behavior of this human body that had been stored before the human body has become undetected, and determines whether this position to which the human body has moved is the blind spot area.

The seat area detection unit 114 detects the seat area 601 in the captured image. The seat area detection unit 114 may detect the seat area 601 by acquiring information indicating the seat area 601 specified by the user or may detect the seat area 601 in the captured image by conducting an image analysis.

The number-of-people counting unit 115 counts the number of human bodies present in the counting target area in the captured image. In the present exemplary embodiment, assume that the counting target area is the seat area 601. The counting target area may be any predetermined area in the vehicle 600 and may be a part or the whole of the area including the seat area 601 and the non-seat area 602.

The image analysis unit 108 notifies the CPU 101 of the result of the above-described processing via the internal bus 110. A part or all of the functions of the image analysis unit 108 can be implemented by the CPU 101 executing a program. However, the image analysis unit 108 may be configured in such a manner that at least a part of the individual elements in the image analysis unit 108 operates as hardware. In this case, the dedicated hardware operates based on the control by the CPU 101.

The compression/decompression unit 109 generates compressed data by performing compression processing on the captured image following a control instruction from the CPU 101 via the internal bus 110. The compressed data is transmitted from the I/F 105 to the client apparatus 500 via the network 400.

The client apparatus 500 includes a CPU 501, a ROM 502, a RAM 503, an 1/F 504, an input/output I/F 505, an input device 506, and a display device 507. The CPU 501, the ROM 502, the RAM 503, and the I/F 504 have similar functions to the above-described CPU 101, ROM 102, RAM 103, and I/F 105 of the imaging apparatus 100.

The input/output I/F 505 includes various kinds of interfaces regarding an input and an output. The input/output I/F 505 is connected to the input device 506, receives instruction information from the input device 506, and notifies the CPU 501 of the information via an internal bus 508. In the present example, the input device 506 includes operation keys including a release switch and a power switch, a cross key, a joystick, a touch panel, a keyboard, a pointing device (e.g., a mouse), and/or the like. Further, the input/output I/F 505 is connected to the display device 507 including a monitor, such as a liquid crystal display (LCD), and displays the captured image transmitted from the imaging apparatus 100 and temporarily stored in the RAM 503, and information such as an operation menu.

In the present exemplary embodiment, the imaging apparatus 100 will be described assuming that the imaging apparatus 100 operates as an information processing apparatus including the image analysis unit 108. However, the client apparatus 500, a commonly-used PC, a cloud server, or the like communicably connected to the imaging apparatus 100 may operate as the above-described information processing apparatus. In this case, the information processing apparatus acquires the captured image captured by the imaging apparatus 100 as the input image via the network 400, and performs processing equivalent to the image analysis unit 108.

Next, the operation of the imaging apparatus 100 according to the present exemplary embodiment will be described specifically.

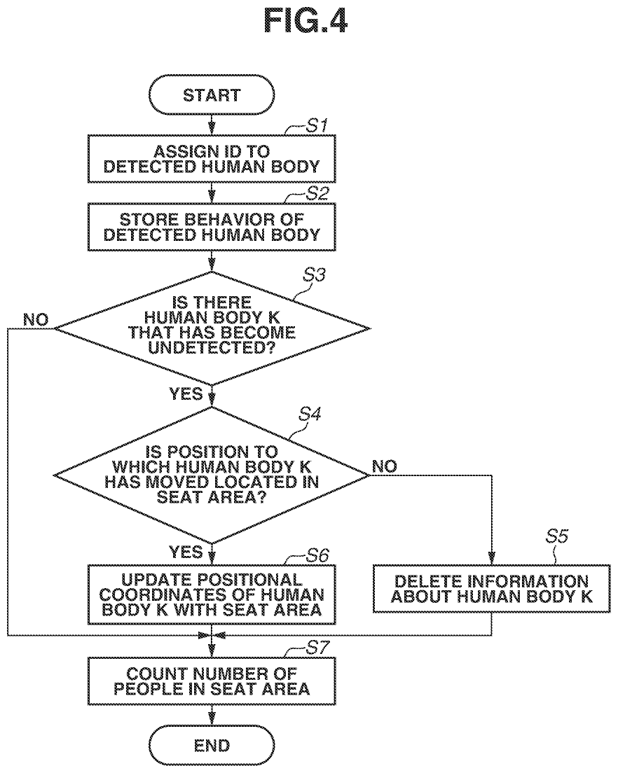

FIG. 4 is a flowchart illustrating a procedure of processing for counting the number of people that is performed by the imaging apparatus 100 according to the present exemplary embodiment.

This processing illustrated in FIG. 4 is started in response to, for example, a user's instruction, and is repeated at a predetermined interval. However, the start timing of the processing illustrated in FIG. 4 is not limited to the above-described timing. The processing illustrated in FIG. 4 may be automatically started at, for example, a timing when the imaging apparatus 100 starts an imaging operation after being started up. The CPU 101 illustrated in FIG. 1 reads out and executes a required program, by which the imaging apparatus 100 can implement each processing procedure illustrated in FIG. 4.

In the present exemplary embodiment, assume that the startup of the imaging apparatus 100 is already completed, and the image analysis unit 108 is ready to conduct the image analysis on the captured image. Further, assume that the seat area detection unit 114 has detected the seat area 601 illustrated in FIG. 2, and the information about the area corresponding to the seat area 601 in the captured image has been taken in the RAM 103.

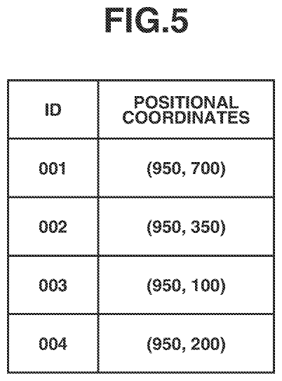

In step S1, the imaging apparatus 100 detects a human body from the captured image. Then, the imaging apparatus 100 assigns an ID to the detected human body and associates the positional coordinates of the detected human body and the ID with each other, and then stores them into the RAM 103 as human body detection information. For example, if four human bodies are detected in step S1, IDs (001 to 004) of the detected human bodies and the positional coordinates of the detected human bodies are stored into the RAM 103 as illustrated in FIG. 5.

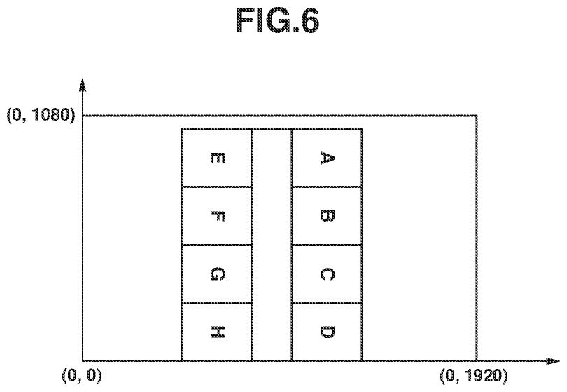

At this time, the central coordinates of the outer shape of the detected human body can be used as the positional coordinates of the human body. As illustrated in FIG. 6, in a case where the image size of the captured image is 1920×1080 pixels, the positional coordinates of the human body are expressed as any of (0, 0) to (1920, 1080). FIG. 5 illustrates the human body detection information in a case where all of the four human bodies having the IDs=001 to 004 are present in the non-seat area 602 illustrated in FIG. 2.

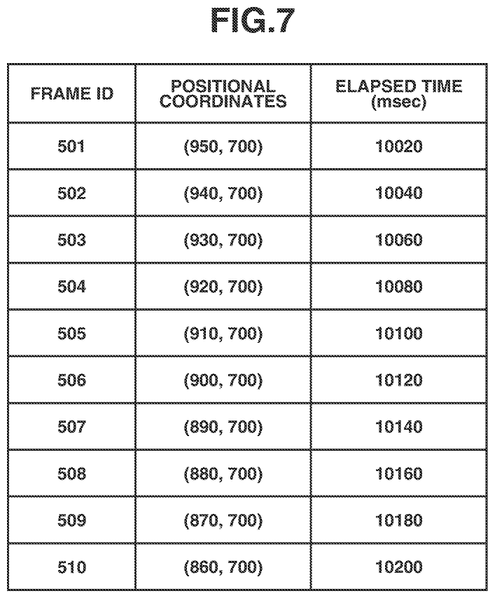

In step S2, the imaging apparatus 100 stores each of the behaviors of the N human bodies detected in step S1 into the RAM 103. More specifically, the imaging apparatus 100 stores the positional coordinates of each of the human bodies in the captured image into the RAM 103 for each frame. For example, assume that the imaging apparatus 100 stores the positional coordinates of the detected human body up to ten frames as the human body behavior information as illustrated in FIG. 7, and the imaging apparatus 100 discards the positional coordinates in the oldest frame and updates them when the positional coordinates are updated.

In step S3, the imaging apparatus 100 determines whether there is a human body K that has become undetected among the N human bodies detected in step S1. For example, if the human body having the ID=001 and the human body having the ID=002 illustrated in FIG. 5 move from the aisle into the seat area 601 to sit down on the seat and enter the blind spot area caused by the backrest 610 of the seat, the human body having the ID=001 and the human body having the ID=002 have become undetected. In this case, the imaging apparatus 100 determines that there is the human body K that has become undetected. If the imaging apparatus 100 determines that there is the human body K that has become undetected in this manner (YES in step S3), the processing proceeds to step S4. On the other hand, if the imaging apparatus 100 determines that there is not the human body K that has become undetected (NO in step S3), the processing proceeds to step S7.

In step S4, the imaging apparatus 100 determines whether the position to which the human body K has moved after having become undetected is the seat area 601. In other words, the imaging apparatus 100 determines whether the position to which the human body K has moved after having become undetected is an area containing the blind spot area. The processing in step S4 will be described in detail below. If the imaging apparatus 100 determines that the position to which the human body K has moved after having become undetected is not the seat area 601 in step S4 (NO in step S4), the processing proceeds to step S5. If the imaging apparatus 100 determines that the position to which the human body K has moved after having become undetected is the seat area 601 in step S4 (YES in step S4), the processing proceeds to step S6.

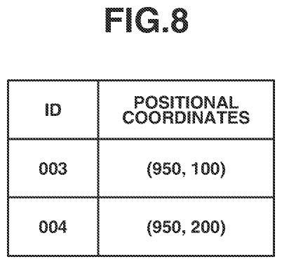

In step S5, the imaging apparatus 100 deletes from the human body detection information the information about the human body K whose movement position after having become undetected is determined not to be the seat area 601. Then, the processing proceeds to step S7. For example, when the human body having the ID=001 and the human body having the ID=002 illustrated in FIG. 5 are determined to become undetected due to a reason other than the movement into the seat area 601, the information about the human body having the ID=001 and the information about the human body having the ID=002 are deleted and the human body detection information is updated as illustrated in FIG. 8.

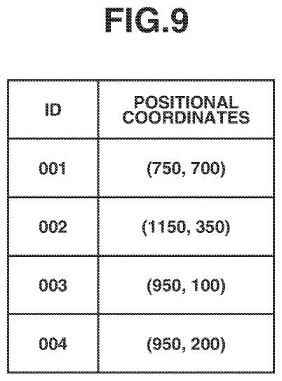

In step S6, the imaging apparatus 100 updates the positional coordinates of the human body K determined to have been undetected with coordinates of the seat area 601. For example, suppose that the human body having the ID=001 and the human body having the ID=002 illustrated in FIG. 5 are estimated to have become undetected by moving to the seat F and the seat C, respectively. In this case, as illustrated in FIG. 9, the positional coordinates of the human body having the ID=001 and the human body having the ID=002 are updated with the central coordinates of areas corresponding to the seat F and the central coordinates of an area corresponding to the seat C, respectively.

In step S7, the imaging apparatus 100 counts the number of people in the seat area 601. More specifically, the imaging apparatus 100 counts the number of human bodies located at positional coordinates in the seat area 601 based on the human body detection information. For example, in a case of the human body detection information illustrated in FIG. 9, the positional coordinates of the human body having the ID=001 and the human body having the ID=002 are coordinates in the seat area 601, and the positional coordinates of the human body having the ID=003 and the human body having the ID=004 are coordinates in the non-seat area 602 (aisle). Accordingly, in this case, the number of people in the seat area 601 is counted to be two.

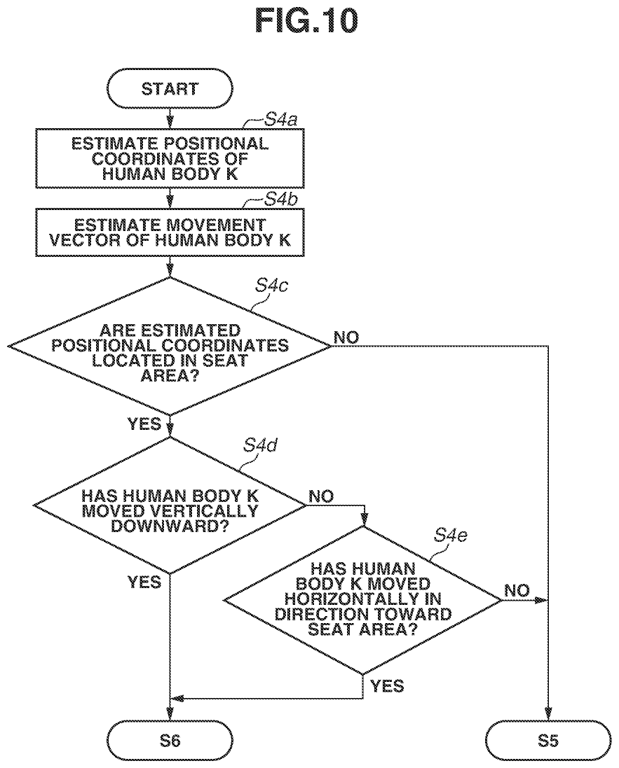

In the following description, the flow of the processing in step S4 illustrated in FIG. 4 will be described specifically with reference to FIG. 10.

If the imaging apparatus 100 determines that there is the human body K that has become undetected in step S3 illustrated in in FIG. 4 (YES in step S3), in step S4a illustrated in FIG. 10, the imaging apparatus 100 estimates the positional coordinates of the human body K after the human body K has become undetected. The imaging apparatus 100 estimates the positional coordinates of the human body K in the frame where the human body K has become undetected based on the human body behavior information, in which the positional coordinates of the human body K in consecutive ten frames before the human body K has become undetected are recorded, like the example illustrated in FIG. 7.

One example of the method for the estimation is a method that determines a gradient a and an intercept b in a regression equation Y=aX+b, where X is the elapsed time and Y is the positional coordinates of the human body K, based on a single regression analysis using the positional coordinates in the ten frames, and calculates the positional coordinates Y while setting the elapsed time of the frame after the human body K has become undetected as X. The method for estimating the positional coordinates based on the single regression analysis is known, and therefore the detailed description thereof will be omitted herein. For example, if the human body exhibiting the behavior illustrated in FIG. 7 has become undetected in the frame ID=511, the positional coordinates of this human body in the frame ID=511 is estimated to be (850, 700).

In step S4b, the imaging apparatus 100 estimates a movement vector indicating the direction in which the human body K having become undetected has moved. The imaging apparatus 100 calculates the movement vector based on the human body behavior information, in which the positional coordinates of the human body K in the consecutive ten frames before the human body K has become undetected are recorded, like the example illustrated in FIG. 7. For example, as illustrated in FIG. 7, assuming that the starting point is the positional coordinates in the frame ID=501 and the end point is the positional coordinates in the frame ID=510, the movement vector of the human body exhibiting the behavior illustrated in FIG. 7 is calculated to be (−90, 0). The method for calculating the movement vector is known, and therefore the detailed description thereof will be omitted herein.

In step S4c, the imaging apparatus 100 determines whether the positional coordinates estimated in step S4a are coordinates in the seat area 601. Then, if the imaging apparatus 100 determines that the estimated positional coordinates are coordinates in the seat area 601 (YES in step S4c), the processing proceeds to step S4d. If the imaging apparatus 100 determines that the estimated positional coordinates are not coordinates in the seat area 601 (NO in step S4c), the processing illustrated in FIG. 10 is ended and the processing proceeds to step S5 illustrated in FIG. 4.

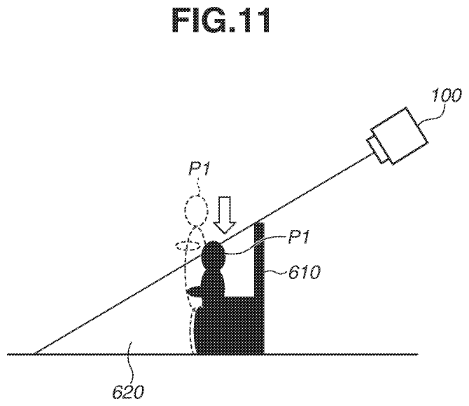

In step S4d, the imaging apparatus 100 determines whether the human body K has moved vertically downward based on the movement vector calculated in step S4b. More specifically, when capturing a captured image like the example illustrated in FIG. 6, the imaging apparatus 100 determines that the human body K has moved vertically downward if the movement vector calculated in step S4b has a negative Y component. Then, when determining that the human body K has moved vertically downward, the imaging apparatus 100 determines that the human body K has become undetected because having moved vertically downward and moved into the blind spot area 620 caused by the backrest 610 from the state being detected in the seat area 601 like a passenger P1 illustrated in FIG. 11. Accordingly, if the imaging apparatus 100 determines that the human body K has moved vertically downward in step S4d illustrated in FIG. 10 (YES in step S4d), the processing illustrated in FIG. 10 is ended and the processing proceeds to step S6 illustrated in FIG. 4. If the imaging apparatus 100 determines that the human body K has not moved vertically downward in step S4d illustrated in FIG. 10 (NO in step S4d), the processing proceeds to step S4e.

The imaging apparatus 100 may be configured to determine whether the human body K has moved vertically downward in the seat area 601 in step S4d. This configuration enables the imaging apparatus 100 to further accurately determine the movement into the blind spot area of the seat.

In step S4e, the imaging apparatus 100 determines whether the human body K has moved horizontally in the direction toward the seat area 601 based on the movement vector calculated in step S4b. More specifically, if the human body K has been determined to have moved to any of the seats A to D illustrated in FIG. 6 in step S4c and the movement vector calculated in step S4b has a positive X component, the imaging apparatus 100 determines that the human body K has moved horizontally in the direction toward the seat area 601. Similarly, if the human body K has been determined to have moved to any of the seats E to H illustrated in FIG. 6 in step S4c and the movement vector calculated in step S4b has a negative X component, the imaging apparatus 100 determines that the human body K has moved horizontally in the direction toward the seat area 601. Then, if the imaging apparatus 100 determines that the human body K has moved horizontally in the direction toward the seat (YES in step S4e), the processing illustrated in FIG. 10 is ended and the processing proceeds to step S6 illustrated in FIG. 4. If the imaging apparatus 100 determines that the human body K has not moved horizontally (NO in step S4e), the processing illustrated in FIG. 10 is ended and the processing proceeds to step S5 illustrated in FIG. 4.

In the above-described manner, the imaging apparatus 100 according to the present exemplary embodiment is installed on the ceiling portion of the vehicle 600. The imaging apparatus 100 images the inside of the vehicle 600, and uses this captured image as the input image and detects the counting target object from this input image. Further, the imaging apparatus 100 stores the history of the position of the detected object in the captured image as the behavior of this object. At this time, a human body can be set as the counting target object. The imaging apparatus 100 determines whether the human body having become undetected has moved from the non-blind spot area into the blind spot area based on the recorded behavior of the human body when the detected human body has become undetected. Now, the blind spot area can be the blind spot area of the seat that is caused depending on the positional relationship between the imaging direction of the imaging apparatus 100 and the backrest 610 of the seat. Then, the imaging apparatus 100 counts the number of human bodies in the counting target area in the captured image based on the result of the human body detection and the determination result about the movement from the non-blind spot area into the blind spot area. In the present example, the seat area 601 in the vehicle 600 can be set as the counting target area.

More specifically, when a human body is detected from the captured image, the imaging apparatus 100 records the information in which the positional coordinates of the detected human body and the ID for identifying the detected human body are associated with each other as the human body detection information. Then, if determining that the human body having become undetected has moved from the non-blind spot area into the blind spot area, the imaging apparatus 100 updates the positional coordinates of this human body recorded as the human body detection information with the positional coordinates in the blind spot area to which the human body has moved. The imaging apparatus 100 can easily recognize the number of human bodies present in the seat area 601 by counting the number of human bodies having the positional coordinates in the seat area 601 recorded in the human body detection information.

In this manner, the imaging apparatus 100 can recognize the result of adding the number of human bodies detected in the area corresponding to the seat area 601 in the captured image and the number of human bodies determined to have moved from the non-blind spot area into the blind spot area in the seat area 601 as the number of human bodies present in the seat area 601.

As a result, the present configuration enables the imaging apparatus 100 to correctly count the number of human bodies in the seat area 601 even when a passenger has moved into the blind spot area of the seat. In other words, when a passenger has moved into the blind spot area of the seat, the passenger has become undetected by the human body detection but can be correctly determined to be present in the blind spot area of the seat, and therefore the count of the number of people can be maintained without being decremented.

Further, the imaging apparatus 100 stores the history of the position in the captured image as the behavior of the human body. Therefore, when the human body has become undetected, the imaging apparatus 100 can estimate the position to which this human body has moved based on the human body behavior information stored before the human body has become undetected. Therefore, when estimating that the position to which the human body having become undetected has moved is the seat area 601, the imaging apparatus 100 can appropriately determine that this human body has moved from the non-blind spot area into the blind spot area of the seat.

Similarly, when the human body has become undetected, the imaging apparatus 100 can estimate the direction in which this human body has moved based the human body behavior information stored before the human body has become undetected. Thus, when estimating that the direction in which the human body having become undetected has moved is the direction toward the seat area 601, the imaging apparatus 100 can appropriately determine that this human body has moved from the non-blind spot area into the blind spot area of the seat.

In this manner, in the present exemplary embodiment, the movement of the human body into the blind spot area of the seat can be determined by the combination of the behavior of the human body detected from the captured image and the determination about the detection and undetection thereof. Therefore, even when the human body has moved from the non-blind spot area into the blind spot area, the count of the number of people is not decremented.

Further, after that, even when the human body has moved from the blind spot area into the non-blind spot area and this human body returns into a detected state, the count of the number of people is prevented from being erroneously incremented. For example, the human body having the ID=001 illustrated in FIG. 9 is a human body present in the blind spot area of the seat. When this human body having the ID=001 stands up from the seat and moves into the non-blind spot area, this human body has become imaged by the imaging apparatus 100 and returns into the state being detected as the human body. In this case, the detected human body is identified as the human body having the ID=001, and the positional coordinates of the human body having the ID=001 are updated with the actually detected positional coordinates. As a result, the human body is prevented from being erroneously determined to be a human body newly detected in the seat area 601, and the count of the number of people is maintained without being incremented.

In this manner, even if a passenger moves in and out between the non-blind spot area and the blind spot area in the vehicle 600, the imaging apparatus 100 can be prevented from increasing or decreasing the count of the number of people when the number of passengers in the vehicle 600 neither increases nor decreases. Therefore, the number of people can be correctly counted.

### Modifications

In the above-described exemplary embodiment, the processing illustrated in FIG. 10 has been described assuming that the imaging apparatus 100 determines whether the direction in which the human body K has moved is the direction toward the area where the blind spot area exists in steps S4d and S4e illustrated in FIG. 10, but is not limited to this example. This processing may be modified so as to proceed to step S6 illustrated in FIG. 4 without the imaging apparatus 100 performing the processing in steps S4d and S4e if the position to which the human body K has moved is determined to be the seat area 601 in step S4c.

Further, in the above-described exemplary embodiment, the processing illustrated in FIG. 10 has been described assuming that the positional coordinates of the human body K in the next frame are estimated based on the single regression analysis in step S4a illustrated in FIG. 10, but is not limited to this example. For example, the positional coordinates in the next frame may be estimated using a multiple regression analysis or the like while using not only the positional coordinates before the human body K has become undetected but also the motion of a body such as a human face, arm, or leg as an input. Further, in step S4a, the positional coordinates in the next frame are estimated therein, but positional coordinates after F frames (F is a real number larger than or equal to zero) or positional coordinates after a predetermined time has elapsed may be estimated.

Further, in the above-described exemplary embodiment, the imaging apparatus 100 may be configured to issue a notification indicating an alert as abnormality detection if the human body K is kept undetected for a predetermined time or longer after having become undetected.

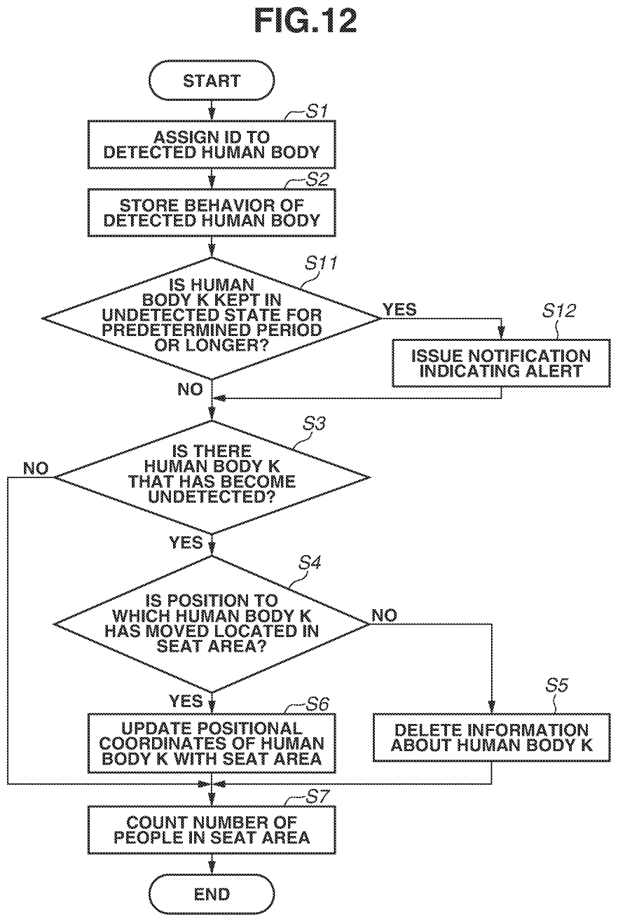

In this case, the imaging apparatus 100 performs processing illustrated in FIG. 12 instead of the processing illustrated in FIG. 4. In FIG. 12, the same step numbers as FIG. 4 are assigned to steps in which similar processing is performed, and the description is given thereof focusing on steps in which different processing is performed in the following description.

In step S11, the imaging apparatus 100 determines whether the human body K is kept in the undetected state for the predetermined time or longer after the human body K has become undetected. Then, if the imaging apparatus 100 determines that the human body K is kept in the undetected state for the predetermined time or longer (YES in step S11), the processing proceeds to step S12. On the other hand, if the imaging apparatus 100 determines that the human body K is not kept in the undetected state for the predetermined time or longer (NO in step S11), the processing proceeds to step S3. In step S12, the imaging apparatus 100 issues the notification as the abnormality detection. For example, the imaging apparatus 100 transmits information indicating the abnormality detection to the client apparatus 500 via the network 400 and causes the information indicating the abnormality detection to be displayed on the display device 507 provided to the client apparatus 500.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-123601, filed Jul. 20, 2020, which is hereby incorporated by reference herein in its entirety.

What is claimed is:

1. An information processing apparatus comprising:
a detection unit configured to detect a counting target object from an input image;
a storage unit configured to store a behavior of the object detected by the detection unit;
a determination unit configured to determine whether the object having become undetected has moved into a specific area based on the behavior of the object stored by the storage unit in a case where the object detected by the detection unit has become undetected; and
a counting unit configured to count a number of objects in a counting target area in the input image based on a detection result of the object by the detection unit and a determination result by the determination unit.

2. The information processing apparatus according to claim 1, wherein the storage unit stores a history of a position of the object detected by the detection unit in the input image.

3. The information processing apparatus according to claim 1, wherein the counting unit counts a number of the objects in the counting target area by adding a number of the objects detected in the counting target area by the detection unit and a number of the objects determined to have moved into the specific area by the determination unit.

4. The information processing apparatus according to claim 1, wherein the determination unit determines, in the case where the object detected by the detection unit has become undetected, that this object has moved into the specific area in a case where a position to which the object having become undetected has moved is estimated to be an area where the specific area exists based on the behavior of this object stored by the storage unit before the object has become undetected.

5. The information processing apparatus according to claim 1, wherein the determination unit determines, in the case where the object detected by the detection unit has become undetected, that the object has moved into the specific area in a case where a direction in which the object having become undetected has moved is estimated to be a direction toward an area where the specific area exists based on the behavior of the object stored by the storage unit before the object has become undetected.

6. The information processing apparatus according to claim 1, further comprising a notification unit configured to issue a notification as abnormality detection in a case where the object determined to have moved into the specific area by the determination unit is kept undetected by the detection unit for a predetermined time or longer.

7. The information processing apparatus according to claim 1, wherein the counting target object is a human body.

8. The information processing apparatus according to claim 1,
wherein the input image is an image captured by an imaging apparatus installed in a vehicle,
wherein the counting target area is a seat area in the vehicle, and
wherein the specific area is an area where a blind spot is caused due to a seat in an angle of view of the imaging apparatus.

9. The information processing apparatus according to claim 8,
wherein the counting target object is a human body, and
wherein the determination unit determines, in the case where the human body detected by the detection unit has become undetected, that the human body has moved into the specific area in a case where the human body having become undetected is estimated to have moved vertically downward based on the behavior of the human body stored by the storage unit before the human body has become undetected.

10. The information processing apparatus according to claim 8,
wherein the counting target object is a human body, and
wherein the determination unit determines, in the case where the human body detected by the detection unit has become undetected, that the human body has moved into the specific area in a case where the human body having become undetected is estimated to have moved horizontally in a direction where the seat exists based on the behavior of the human body stored by the storage unit before the human body has become undetected.

11. An imaging apparatus comprising:
the information processing apparatus according to claim 1; and
an imaging unit installed on a ceiling portion of a vehicle and configured to capture the input image.

12. An information processing method comprising:
detecting a counting target object from an input image;
storing a behavior of the detected object;
determining, in a case where the object has become undetected, whether the object having become undetected has moved into a specific area based on the behavior of the object; and
counting a number of objects in a counting target area in the input image based on the detection result of the object and the determination result.

13. A storage medium storing a program for causing a computer to execute an information processing method, the information processing method comprising:
detecting a counting target object from an input image;
storing a behavior of the detected object;
determining, in a case where the object has become undetected, whether the object having become undetected has moved into a specific area based on the behavior of the object; and
counting a number of objects in a counting target area in the input image based on the detection result of the object and the determination result.
